(19) United States
(12) Patent Application Publication
(10) Pub. No.: US 2020/0214490 A1
(43) Pub. Date: Jul. 9, 2020

(54) CAPSULE SEAT DEVICE FOR A COFFEE MACHINE

(71) Applicant: YA HORNG ELECTRONIC CO., LTD., Tainan City (TW)

(72) Inventor: Jin-Yi HUANG, Tainan City (TW)

(21) Appl. No.: 16/539,257

(22) Filed: Aug. 13, 2019

(30) Foreign Application Priority Data
Jan. 4, 2019 (TW) 108100352

(51) Int. Cl. A47J 31/40; A47J 31/44

(52) U.S. Cl. CPC A47J 31/407; A47J 31/4403

(57) ABSTRACT

A capsule seat device is adapted for use in a coffee machine and includes a seat unit, a receiving unit, a control unit and at least one linkage unit. The seat unit includes a base subunit that has a base surface cooperating with an imaginary horizontal reference plane to define an inclined angle therebetween which ranges between 20 degrees and 40 degrees. The receiving unit is disposed above the base surface, is aligned with the base surface along a normal axis which is normal to the base surface. The at least one linkage unit is connected to the receiving unit and the control unit, such that operation of the control unit drives the receiving unit to move toward or away from the base surface along the normal axis.

### CROSS-REFERENCE TO RELATED APPLICATION

This application claims priority of Taiwanese Patent Application No. 108100352, filed on Jan. 4, 2019.

### FIELD

The disclosure relates to a coffee machine, and more particularly to a capsule seat device adapted for use in a coffee machine.

### BACKGROUND

Referring to FIGS. 1 and 2, a conventional capsule seat device is adapted for use in a coffee machine. The capsule seat device includes a receiving unit 12, a control unit 13, and a linkage unit 14 connected between the receiving unit 12 and the control unit 13.

The receiving unit 12 includes a receiving seat 121 for receiving a coffee capsule 11, a piercing spike (not shown) disposed inside the receiving seat 121 for piercing the coffee capsule 11, and an inlet tube 122 in fluid communication with the receiving seat 121 for injecting hot water into the coffee capsule 11 received by the receiving seat 121.

The control unit 13 includes a handle 131, and a gear 132 connected to the handle 131. The linkage unit 14 includes two linkage rods 141 pivotally connected together, and respectively connected to the receiving seat 121 of the receiving unit 12 and the gear 132 of the control unit 13.

The conventional capsule seat device is convertible between a first state (see FIG. 1) and a second state (see FIG. 2). When the conventional capsule seat device is in the first state, the piercing spike of the receiving unit 12 pierces the coffee capsule 11, allowing the hot water to enter the coffee capsule 11 via the inlet tube 122 of the receiving unit 12 and to be mixed with ingredients inside the coffee capsule 11. Afterwards, a user can pull up the handle 131 to convert the capsule seat device to the second state, in which the coffee capsule 11 is discharged from the receiving seat 121 of the receiving unit 12, so that the used coffee capsule 11 may be taken out and be replaced by a new coffee capsule 11.

Since the receiving seat 121 moves horizontally during the conversion of the conventional capsule seat device between the first and second states, and the hot water is delivered horizontally to the coffee capsule 11, the conventional capsule seat device cannot draw on gravity to facilitate the abovementioned operation. In other words, the injecting process of the hot water and the discharging process of the coffee capsule 11 cannot be performed at their most efficient states due to the abovementioned horizontal configuration.

### SUMMARY

Therefore, the object of the disclosure is to provide a capsule seat device that can alleviate the drawback of the prior art.

According to the disclosure, the capsule seat device is adapted for use in a coffee machine. The capsule seat device includes a seat unit, a receiving unit, a control unit and at least one linkage unit.

The seat unit includes a base subunit and a support wall subunit. The base subunit has a base surface cooperating with an imaginary horizontal reference plane to define an inclined angle therebetween. The inclined angle ranges between 20 degrees and 40 degrees. The support wall subunit is connected to the base subunit. The receiving unit is disposed above the base surface, is aligned with the base surface along a normal axis which is normal to the base surface, and is adapted for receiving a coffee capsule. The control unit is connected to the wall subunit. The at least one linkage unit is pivotally connected to the receiving unit, and is connected to the control unit such that operation of the control unit drives the receiving unit to move toward or away from the base surface along the normal axis.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary and partially sectional view of a conventional capsule seat device in a first state;

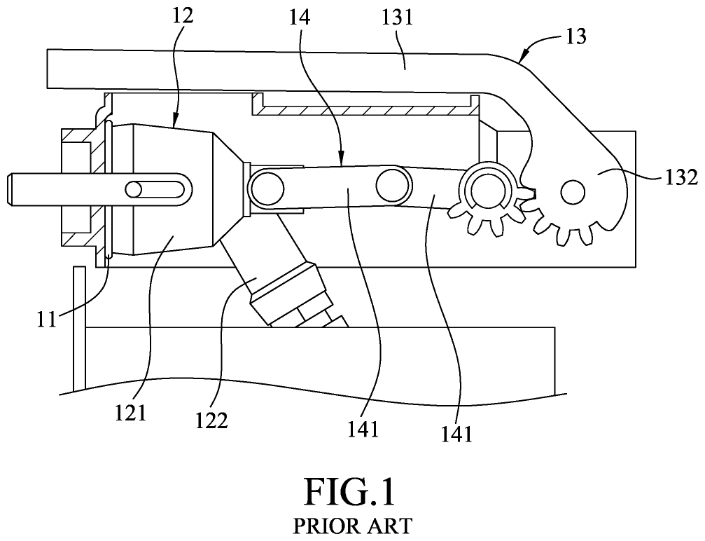

FIG. 2 is another fragmentary and partially sectional view of the conventional capsule seat device in a second state;

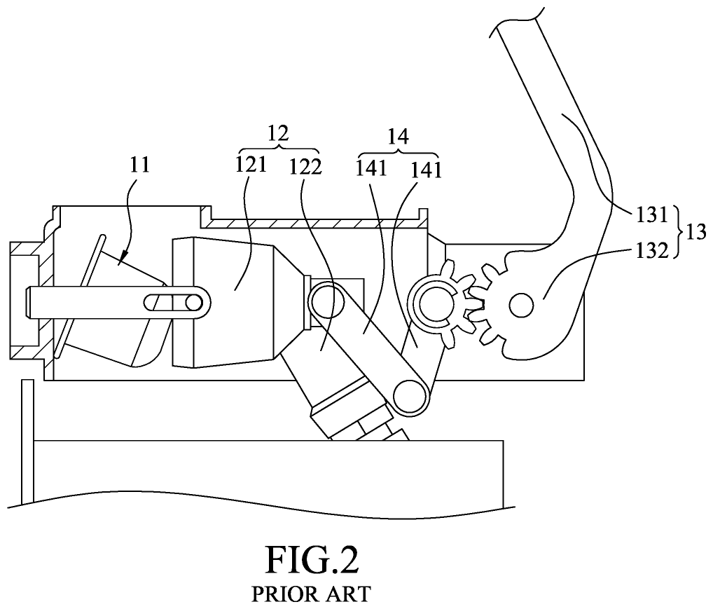

FIG. 3 is a partially exploded perspective view of a coffee machine mounted with a first embodiment of a capsule seat device according to the disclosure;

FIG. 4 is a perspective view illustrating the first embodiment of the capsule seat device in a first state;

FIG. 5 is an exploded perspective view of the first embodiment of the capsule seat device;

FIG. 6 is an assembled sectional view of the first embodiment of the capsule seat device, illustrating the capsule seat device in the first state;

FIG. 7 is another assembled sectional view of the first embodiment, illustrating the capsule seat device in a second state with a coffee capsule disposed on a seat unit;

FIG. 8 is yet another assembled sectional view of the first embodiment, illustrating the capsule seat device in the first state with the coffee capsule received in a receiving seat;

FIG. 9 is yet another assembled sectional view of the first embodiment, illustrating the capsule seat device in a middle state with the coffee capsule remaining in the receiving seat;

FIG. 10 is yet another assembled sectional view of the first embodiment, illustrating the capsule seat device being moved from the middle state toward the second state with the coffee capsule being discharged from the receiving seat;

FIG. 11 is a perspective view of a first linking members of a second embodiment of the capsule seat device according to the disclosure; and

FIG. 12 is an assembled sectional view of the second embodiment, illustrating the capsule seat device in the middle state.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

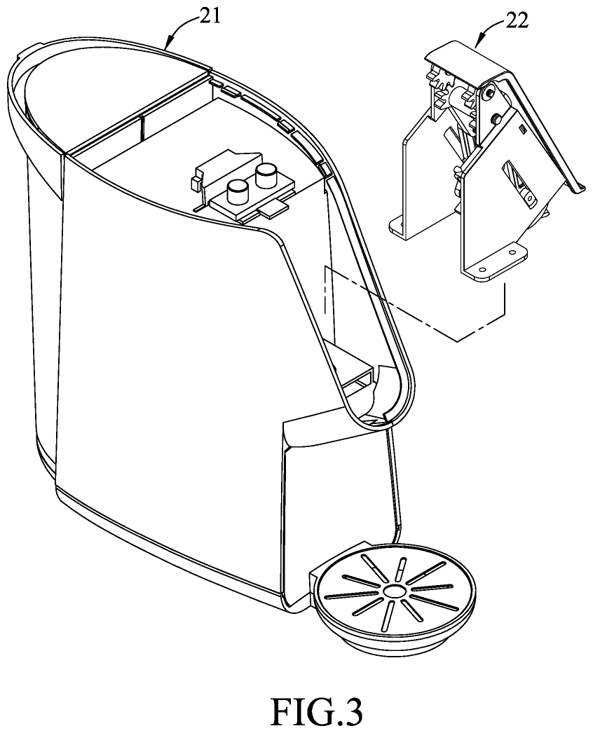

Referring to FIGS. 3, 4 and 5, a first embodiment of a capsule seat device 22 according to the disclosure is adapted for use in a coffee machine. The coffee machine further includes a machine body 21, a water supply device (not shown) and a power supply device (not shown). The capsule seat device 22 is adapted to be mounted to the machine body 21. The water supply device is mounted in the machine body 21 for supplying hot water to the capsule seat device 22, and the power supply device is mounted in the machine body 21 for supplying power for operation of the coffee machine. Since technical and operational details of the water and power supply devices are known in the art and are not of interest in the present disclosure, they are not described in further details hereinafter.

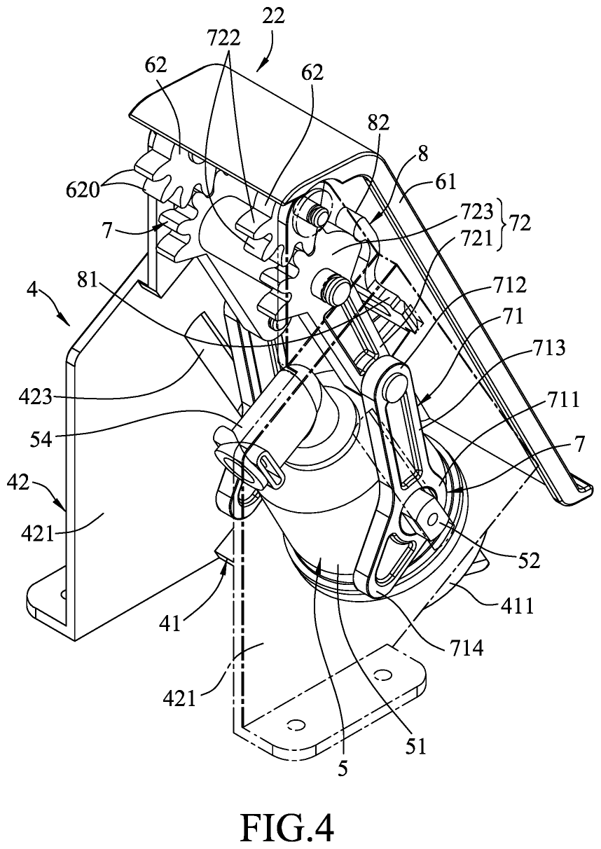

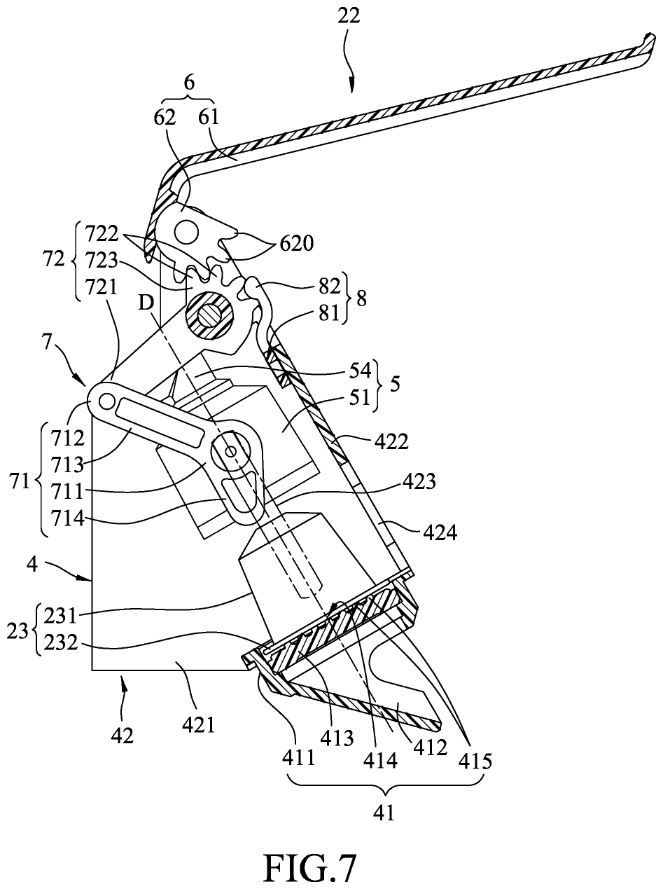

Referring to FIGS. 4 to 7, the capsule seat device 22 is adapted for retaining a coffee capsule 23 (see FIG. 7) therein. The coffee capsule 23 has a surrounding wall 231 and a rim 232. The surrounding wall 231 has a frusto-conical tail end and a head end opposite to the tail end. The rim 232 is connected to the head end of the surrounding wall 231. The coffee capsule 23 contains ingredients for brewing one of various types of coffee drink, such as black coffee, caffè latte, caffè mocha, cappuccino or caramel macchiato.

The capsule seat device 22 includes a seat unit 4, a receiving unit 5, a control unit 6, two linkage units 7 and a stopping unit 8.

The seat unit 4 includes a base subunit 41 and a support wall subunit 42.

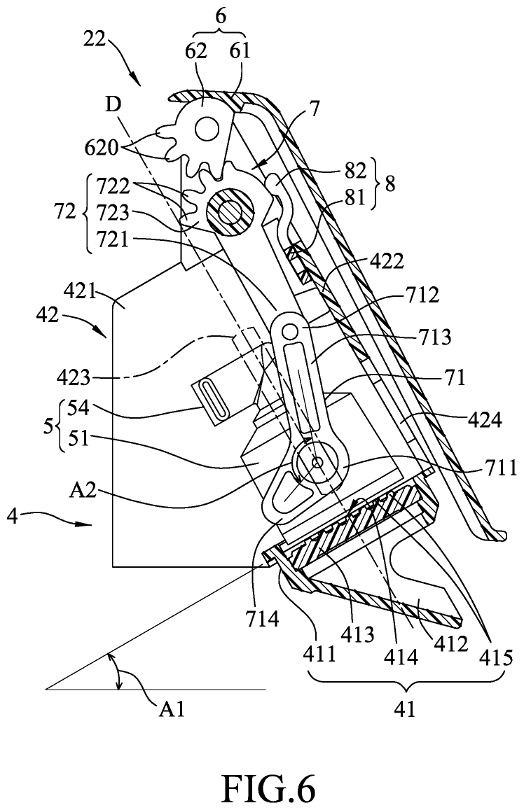

The base subunit 41 includes a hollow disc seat 411, a fluid guiding seat 412 that is connected to a bottom end of and in fluid communication with the disc seat 411, and a filter plate 413 that is embedded in the disc seat 411 and that has a base surface 414 formed with a plurality of piercing spikes 415. The base surface 414 cooperates with an imaginary horizontal reference plane to define an inclined angle (A1) therebetween (see FIG. 6), and the inclined angle (A1) ranges between 20 degrees and 40 degrees. In the present embodiment, the inclined angle (A1) is 30 degrees.

In virtue of the abovementioned configuration, during the coffee brewing process, the coffee drink is allowed to flow out of the coffee capsule 23 via pierced holes made by the piercing spikes 415, then through the filter plate 413 in the disc seat 411, and finally out of the coffee machine via the fluid guiding seat 412 for user consumption. In the meantime, the filter plate 413 is able to prevent the ingredients, such as coffee grounds, from flowing out of the coffee machine and from resulting in an unpleasant drinking experience.

The support wall subunit 42 of the seat unit 4 includes two side walls 421 that are spaced apart in a left-right direction, and that are respectively connected to opposite ends of the disc seat 411 of the base subunit 41, and a front wall 422 that is connected between the side walls 421. Each of the side walls 421 is formed with a guiding slot 423 that extends in a direction of a normal axis (D) which is normal to the base surface 414. The front wall 422 cooperates with the base subunit 41 to define an input opening 424 adapted for insertion of the coffee capsule 23 therethrough into the seat unit 4.

The receiving unit 5 includes a capsule seat 51, two guiding blocks 52, a piercing member 53 and an inlet tube 54. The capsule seat 51 is disposed above the base surface 414 of the seat unit 4, is aligned with the base surface 414 along the normal axis (D) (see FIGS. 6 and 7), and has an inner surface that defines an inner space adapted for receiving the coffee capsule 23. More specifically, the inner surface of the capsule seat 51 is formed with an anti-slip wave pattern (not shown) to prevent the coffee capsule 23 from accidentally falling out of the capsule seat 51 during operation. The guiding blocks 52 protrude respectively from opposite ends of the capsule seat 51 in the left-right direction. Each of the guiding blocks 52 is engaged with the guiding slot 423 of a respective one of the side walls 421, and is slidable along the guiding slot 423 of the respective one of the side walls 421 in the direction of the normal axis (D). The piercing member 53 is connected to the inner surface of the capsule seat 51, and is adapted for piercing the coffee capsule 23 received in the capsule seat 51. The inlet tube 54 is connected to and in fluid communication with the capsule seat 51, such that hot water may be injected into the capsule seat 51 via the inlet tube 54. The hot water further enters the coffee capsule 23 received in the capsule seat 51 via pierced holes made by the piercing member 53.

It should be noted that, in the present embodiment, the guiding slot 423 of each of the side walls 421 is a through hole. However, in other variations of the embodiment, the guiding slot 423 of each of the side walls 421 may be a blind hole as long as each of the guiding blocks 52 is slidable along the guiding slot 423 of the respective one of the side walls 421.

The control unit 6 includes an elongated handle 61, and two gears 62 that are spaced apart from each other in the left-right direction and that are fixedly connected to an end portion of the handle 61. Each of the gears 62 has a plurality of gear teeth 620, and is rotatably connected to a top portion of a respective one of the side walls 421 of the support wall subunit 42, such that the handle 61 is pivotable relative to the support wall subunit 42 between a press-down position (see FIG. 6), where the other end portion of the handle 61 is proximate to the seat unit 4, and a pull-up position (see FIG. 7), where the other end portion of the handle 61 is distal from the seat unit 4. The user can pivot the handle 61 of the control unit 6 to initiate an operation of the control unit 6.

Each of the linkage units 7 is disposed between the receiving unit 5 and the control unit 6, and includes a first linking member 71 and a second linking member 72.

The first linking member 71 of each of the linkage units 7 has a first pivot portion 711, a second pivot portion 712, an extending portion 713 and a protruding portion 714.

For the first linking member 71 of each of the linkage units 7, the first pivot portion 711 is substantially ring-shaped, and is rotatably connected to the receiving unit 5. The second pivot portion 712 is distal from the first pivot portion 711. The extending portion 713 extends along an imaginary line that extends between the first and second pivot portions 711, 712, and interconnects the first and second pivot portions 711, 712. The protruding portion 714 protrudes from the first pivot portion 711 along an axis transverse to the imaginary line. More specifically, as shown in FIG. 6, the imaginary line and the axis cooperatively define a protruding angle (A2) that ranges between 120 degrees and 140 degrees. In the present embodiment, the protruding angle (A2) is 130 degrees.

The second linking member 72 of each of the linkage units 7 has a pivot end portion 721, and a gear end portion 723 having a plurality of gear teeth 722. The gear teeth 722 are formed only along a portion of the periphery of the pivot end portion 721.

For each of the linkage units 7, the pivot end portion 721 of the second linking member 72 is pivotally connected to the second pivot portion 712 of the first linking member 71. The gear end portion 723 of the second linking member 72 is pivotally connected to a respective one of the side walls 421 of the seat unit 4. The gear teeth 722 of the gear end portion 723 of the second linking member 72 mesh with the gear teeth 620 of a respective one of the gears 62 of the control unit 6 such that the abovementioned operation of the control unit 6 drives rotation of the gear end portion 723 of the second linking member 72, thereby resulting in a pivotal movement of the first linking member 71 relative to the receiving unit 5 between a first position (see FIG. 6) and a second position (see FIG. 7). The pivotal movement of the two first linking members 71 of the two linkage units 7 simultaneously drives a linear movement of the receiving unit 5 toward or away from the base surface 414 along the normal axis (D) via the pivot connection between the two first linking members 71 and the receiving unit 5.

For each of the linkage units 7, when the first linking member 71 is at the first position, the receiving unit 5 is adjacent to the base surface 414 of the base unit 4, and the protruding portion 714 is transverse to the normal axis (D). When the first linking member 71 is at the second position, the receiving unit 5 is away from the base surface 414 along the normal axis (D), and the protruding portion 714 is substantially parallel to the normal axis (D).

The stopping unit 8 includes a connecting member 81 and two stopping members 82. The connecting member 81 is disposed at a top portion of the front wall 422 of the seat unit 4, and is mounted between the side walls 421 of the seat unit 4. The stopping members 82 are spaced apart from each other in the left-right direction, and extend upwardly from the connecting member 81. When the first linking member 71 of each of the linkage units 7 is at the second position, each of the stopping members 82 is engaged with the gear teeth 722 of the gear end portion 723 of the second linking member 72 of a respective one of the linkage units 7 for arresting the rotation of the gear end portion 723, thereby positioning the position of the receiving unit 5.

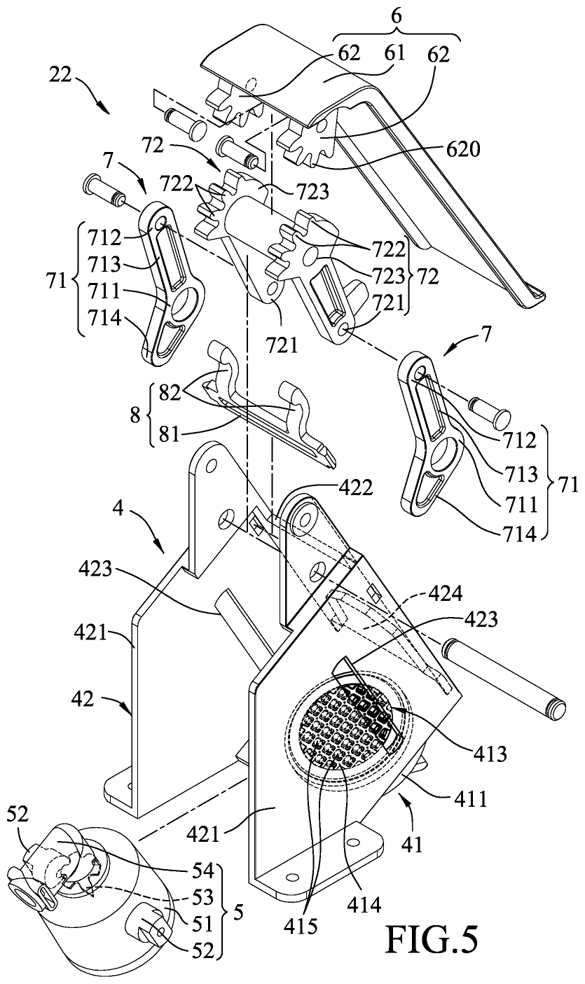

Referring to FIGS. 5, 6 and 7, the capsule seat device 22 is convertible between a first state (see FIG. 6) and a second state (see FIG. 7). The capsule device 22 is in the first state when the handle 61 of the control unit 6 is at the press-down position, and is in the second state when the handle 61 of the control unit 6 is at the pull-up position.

When the capsule seat device 22 is in the first state, each of the stopping members 82 rests on a portion of the periphery of the gear end portion 723 of the second linking member 72 of the respective one of the linkage units 7 (i.e., each of the stopping members 82 is not engaged with the gear teeth 722 of the second linking member 72 of the respective one of the linkage units 7), the first linking member 71 of each of the linkage units 7 is at the first position, and the receiving unit 5 is adjacent to the base surface 414 of the base unit 4.

When the capsule seat device 22 is in the second state, each of the stopping members 82 is engaged with the gear teeth 722 of the second linking member 72 of the respective one of the linkage units 7, the first linking member 71 of each of the linkage units 7 is at the second position, and the receiving unit 5 is away from the base surface 414 of the base unit 4.

For a better understanding of the capsule seat device 22 of the present embodiment, an operation process of the coffee machine is described as follows.

Prior to an operation of the coffee machine, the capsule seat device 22 is in the first state (see FIG. 6), and the coffee capsule 23 is not yet inserted into the capsule seat device 22.

To start the operation, the user lifts the handle 61 of the control unit 6 to the pull-up position, so that each of the gears 62 of the control unit 6 drives the pivot action of the second linking member 72 of the respective one of the linkage units 7, and consequently drives the first linking member 71 of the respective one of the linkage units 7 to convert from the first position to the second position, and simultaneously moving the receiving unit 5 away from the base surface 414 along the normal axis (D), thereby converting the capsule seat device 22 to the second state.

Next, as the capsule seat device 22 remains in the second state, the user inserts the coffee capsule 23 into the seat unit 4 via the input opening 424 of the seat unit 4, and the coffee capsule 23 is disposed on the base surface 414 of the seat unit 4 (see FIG. 7).

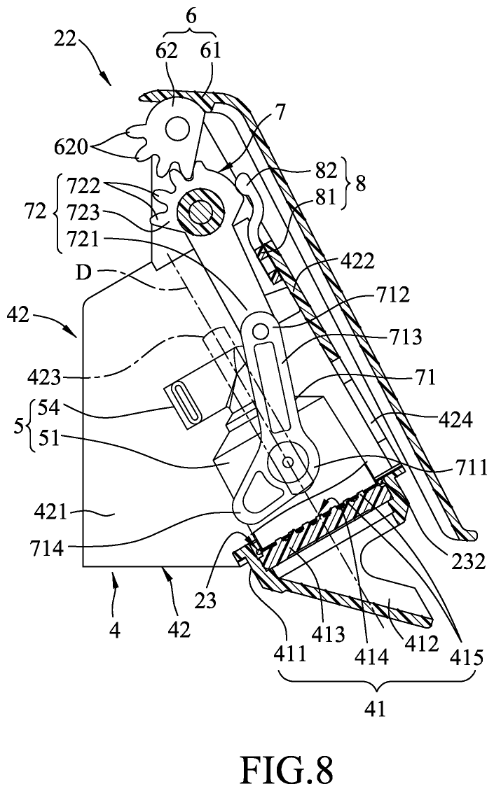

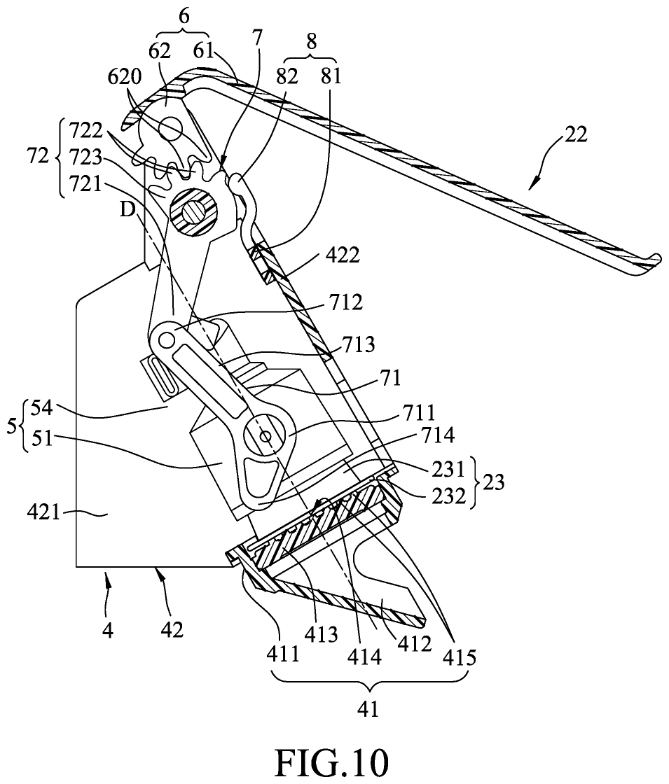

Then, referring to FIGS. 8, 9 and 10, the user presses the handle 61 to the press-down position, converting the capsule seat device 22 to the first state again (see FIG. 8). As the receiving unit 5 moves toward the base surface 414, the coffee capsule 23 is received by the capsule seat 51 of the receiving unit 5, the piercing members 53 in the capsule seat 51 pierce through the tail end of the surrounding wall 231 of the coffee capsule 23, and the piercing spikes 415 of the base surface 414 pierce through the head end of the surrounding wall 231 of the coffee capsule 23. At this point, the hot water, supplied by the water supply device and having passed through the inlet tube 54 and the capsule seat 51 of the receiving unit 5, is allowed to enter the coffee capsule 23 and flow through the ingredients therein to turn into the coffee drink. The coffee drink then exits the coffee capsule 23, flows through the filter plate 413 of the seat unit 4, and flows out of the coffee machine via the fluid guiding seat 412.

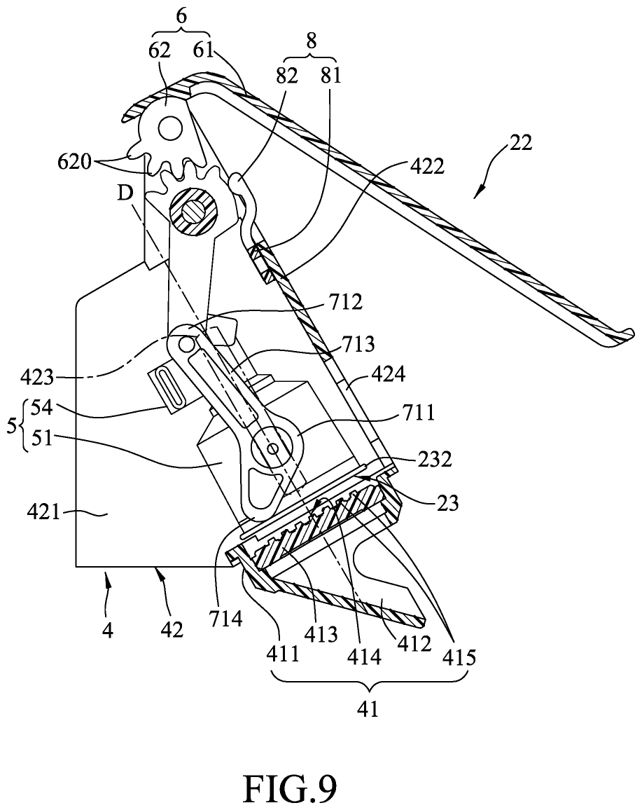

Afterwards, in order to discharge the used coffee capsule 23, the user lifts the handle 61 again to the pull-up position to convert the capsule seat device 22 to the second state. It should be noted that during this conversion process, the capsule seat device 22 is converted to a middle state as shown in FIG. 9, where the first linking member 71 of each of the linkage units 7 is slightly pivoted toward the second position and where the protruding portion 714 of the first linking member 71 of each of the linkage units 7 is pivoted to contact the rim 232 of the coffee capsule 23. As the converting process continues, the protruding portion 714 of each of the linkage units 7 presses against the rim 232 and causes the coffee capsule 23 to be discharged from the capsule seat 51 of the receiving unit 5 along the normal axis (D).

Finally, when the coffee capsule 23 is fully discharged from the receiving unit 5 and the capsule seat device 22 is in the second state as shown in FIG. 7, it can be removed and the operation is then completed.

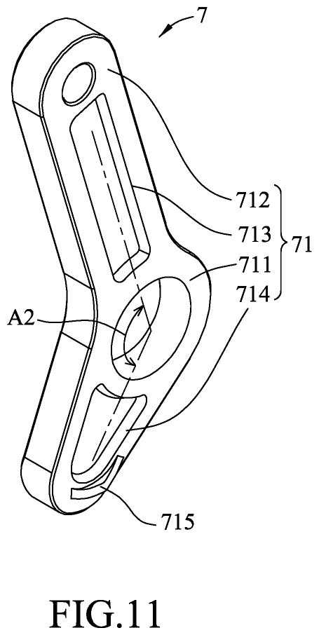

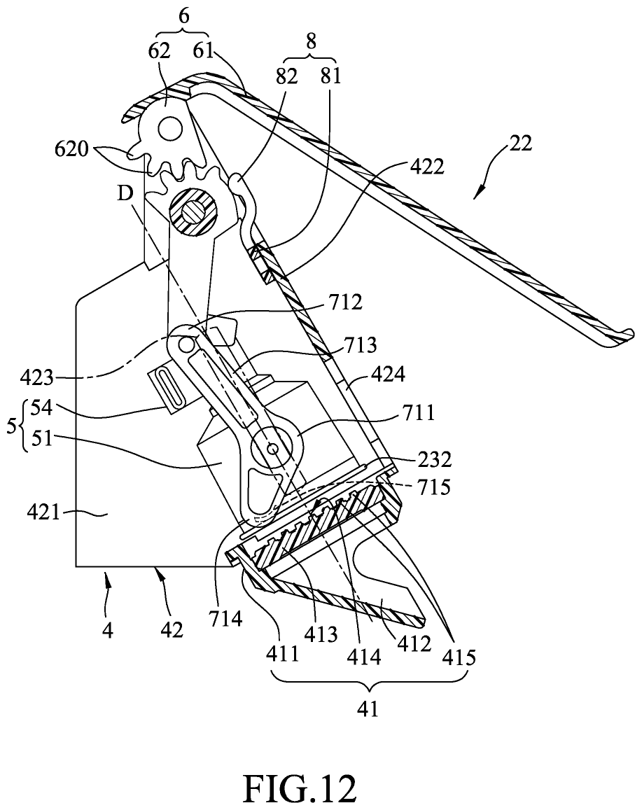

Referring to FIGS. 11 and 12, a second embodiment of the capsule seat device 22 according to the disclosure is similar to the first embodiment. The difference between the two embodiments resides in that the first linking member 71 of each of the linkage units 7 further has a side protrusion 715 protruding from the protruding portion 714 thereof toward the receiving unit 5.

When the capsule seat device 22 is in the middle state during the conversion process as mentioned above, the side protrusion 715 of the first linking member 71 of each of the linkage units 7 contacts the rim 232 of the coffee capsule 23. As the converting process continues, the side protrusion 715 of each of the linkage units 7 presses against the rim 232 and causes the coffee capsule 23 to be discharged from the capsule seat 51 of the receiving unit 5 along the normal axis (D).

In summary, the capsule seat device 22 according to the present disclosure has advantages as follows.

Referring to FIGS. 4, 5 and 6, by virtue of the inclined configuration of the base surface 414, the movement of the capsule seat 51 along the normal axis (D) is nearly-vertical. Therefore, the discharging process of the coffee capsule 23 can benefit from gravity and become more efficient.

Moreover, continuing on the abovementioned configuration, gravity also facilitates the flowing process of the hot water into the capsule seat 51 and through the coffee capsule 23 as well as the flowing process of the coffee drink out of the coffee machine.

In virtue of configurations of the guiding slots 423 and the guiding blocks 52, the capsule seat 51 is ensured to move along the normal axis (D) without deviation, and the capsule seat 51 also benefits from gravity to press the coffee capsule 23 against the base surface 414 more efficiently when the capsule seat device 22 is in the first state.

In virtue of configuration of the first linking member 71 of each of the linkage unit 7 with the protruding angle (A2) ranging between 120 degrees and 140 degrees, the protruding portions 714 are not obstructed by the seat unit 4 when the capsule seat device 22 is in the first state, and are able to discharge the coffee capsule 23 from the capsule seat 51 when the capsule seat device 22 is from the first state to the second state.

Lastly, in the second embodiment of the disclosure, configuration of the side protrusion 715 of each of the linkage units 7 provides an alternative to discharge the coffee capsule 23, which demonstrates the flexible configurations of the present disclosure.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A capsule seat device adapted for use in a coffee machine, said capsule seat device comprising:
a seat unit including
a base subunit that has a base surface cooperating with an imaginary horizontal reference plane to define an inclined angle therebetween, said inclined angle ranging between 20 degrees and 40 degrees, and
a support wall subunit that is connected to said base subunit;
a receiving unit disposed above said base surface, aligned with said base surface along a normal axis which is normal to said base surface, and adapted for receiving a coffee capsule;
a control unit connected to said wall subunit; and
at least one linkage unit pivotally connected to said receiving unit, and connected to said control unit, such that operation of said control unit drives said receiving unit to move toward or away from said base surface along the normal axis.

2. The capsule seat device as claimed in claim 1, wherein said at least one linkage unit includes:
a first linking member having
a first pivot portion that is rotatably connected to said receiving unit,
a second pivot portion that is distal from said first pivot portion, and
a protruding portion that protrudes from said first pivot portion; and
a second linking member pivotally connected to said second pivot portion of said first linking member, and connected to said control unit, such that the operation of said control unit drives said first linking member to pivot relative to said receiving unit between a first position, where said receiving unit is adjacent to said base surface of said base unit for abutting the coffee capsule against said base surface and where said protruding portion is transverse to the normal axis, and a second position, where said receiving unit is away from said base surface along the normal axis and where said protruding portion is substantially parallel to the normal axis for discharging the coffee capsule from said receiving unit.

3. The capsule seat device as claimed in claim 2, wherein an imaginary line which extends between said first and second pivot portions of said first linking member of said at least one linkage unit and an axis along which said protruding portion of said first linking member extends cooperatively define a protruding angle that ranges between 120 degrees and 140 degrees.

4. The capsule seat device as claimed in claim 2, wherein:
said control unit has an end portion formed with a plurality of gear teeth;
said second linking member of said at least one linkage unit has a pivot end portion pivotally connected to said second pivot portion of said first linking member of said at least one linkage unit, and a gear end portion having a plurality of gear teeth that mesh with said gear teeth of said control unit such that the operation of said control unit drives rotation of said gear end portion of said second linking member of said at least one linkage unit, thereby resulting in the pivot movement of said first linking member of said at least one linkage unit; and
said capsule seat device further comprises a stopping unit mounted to said support wall subunit, and being engaged with said gear teeth of said gear end portion of said at least one linkage unit when said first linking member of said at least one linkage unit is at the first position for arresting the rotation of said gear end portion of said at least one linkage unit, thereby positioning the position of said receiving unit.

5. The capsule seat device as claimed in claim 1, wherein said at least one linkage unit includes:
a first linking member having
a first pivot portion that is rotatably connected to said receiving unit,
a second pivot portion that is distal from said first pivot portion,
a protruding portion that protrudes from said first pivot portion, and
a side protrusion that protrudes from said protruding portion toward said receiving unit; and
a second linking member pivotally connected to said second pivot portion of said first linking member, and connected to said control unit, such that the operation of said control unit drives said first linking member to pivot relative to said receiving unit between a first position, where said receiving unit is adjacent to said base surface of said base unit for abutting the coffee capsule against said base surface and where said protruding portion is transverse to the normal axis, and a second position, where said receiving unit is away from said base surface along the normal axis and where said protruding portion is substantially parallel to the normal axis so that said side protrusions discharge the coffee capsule from said receiving unit.

6. The capsule seat device as claimed in claim 5, wherein an imaginary line which extends between said first and second pivot portions of said first linking member of said at least one linkage unit and an axis along which said protruding portion of said first linking member of said at least one linkage unit extends cooperatively define a protruding angle that ranges between 120 degrees and 140 degrees.

7. The capsule seat device as claimed in claim 5, wherein:
said control unit has an end portion formed with a plurality of gear teeth;
said second linking member of said at least one linkage unit has a pivot end portion pivotally connected to said second pivot portion of said first linking member of said at least one linkage unit, and a gear end portion having a plurality of gear teeth that mesh with said gear teeth of said control unit such that the operation of said control unit drives rotation of said gear end portion of said second linking member of said at least one linkage unit, thereby resulting in the pivot movement of said first linking member of said at least one linkage unit; and
said capsule seat device further comprises a stopping unit mounted to said support wall subunit, and being engaged with said gear teeth of said gear end portion of said at least one linkage unit when said first linking member of said at least one linkage unit is at the first position for arresting the rotation of said gear end portion of said at least one linkage unit, thereby positioning the position of said receiving unit.

8. The capsule seat device as claimed in claim 1, wherein said capsule seat device comprises two of said linkage units, and said support wall subunit includes two spaced-apart side walls connected respectively to said linkage units.

9. The capsule seat device as claimed in claim 8, wherein each of said linkage units includes:
a first linking member having
a first pivot portion that is rotatably connected to said receiving unit,
a second pivot portion that is distal from said first pivot portion, and
a protruding portion that protrudes from said first pivot portion; and
a second linking member pivotally connected to said second pivot portion of said first linking member, and connected to said control unit, such that the operation of said control unit drives said first linking member of each of said linkage units to pivot relative to said receiving unit between a first position, where said receiving unit is adjacent to said base surface of said base unit for abutting the coffee capsule against said base surface and where said protruding portion of each of said linkage units is transverse to the normal axis, and a second position, where said receiving unit is away from said base surface along the normal axis and where said protruding portion of each of said linkage units is substantially parallel to the normal axis for discharging the coffee capsule from said receiving unit.

10. The capsule seat device as claimed in claim 9, wherein, for each of said linkage units, an imaginary line which extends between said first and second pivot portions of said first linking member and an axis along which said protruding portion of said first linking member extends cooperatively define a protruding angle that ranges between 120 degrees and 140 degrees.

11. The capsule seat device as claimed in claim 9, wherein:
said control unit has an end portion formed with a plurality of gear teeth;
for each of said linkage units, said second linking member has a pivot end portion pivotally connected to said second pivot portion of said first linking member, and a gear end portion having a plurality of gear teeth that mesh with said gear teeth of said control unit such that the operation of said control unit drives rotation of said gear end portion of said second linking member, thereby resulting in the pivot movement of said first linking member; and
said capsule seat device further comprises a stopping unit mounted between said side walls of said support wall subunit, and being engaged with said gear teeth of said gear end portion of each of said linkage units when said first linking member of each of said linkage units is at the first position for arresting the rotation of said gear end portion of each of said linkage units, thereby positioning the position of said receiving unit.

12. The capsule seat device as claimed in claim 8, wherein each of said linkage units includes:
a first linking member having
a first pivot portion that is rotatably connected to said receiving unit,
a second pivot portion that is distal from said first pivot portion,
a protruding portion that protrudes from said first pivot portion, and
a side protrusion that protrudes from said protruding portion toward said receiving unit; and
a second linking member pivotally connected to said second pivot portion of said first linking member, and connected to said control unit, such that the operation of said control unit drives said first linking member of each of said linkage units to pivot relative to said receiving unit between a first position, where said receiving unit is adjacent to said base surface of said base unit for abutting the coffee capsule against said base surface and where said protruding portion of each of said linkage units is transverse to the normal axis, and a second position, where said receiving unit is away from said base surface along the normal axis and where said protruding portion of each of said linkage units is substantially parallel to the normal axis so that said side protrusions of said linkage units discharge the coffee capsule from said receiving unit.

13. The capsule seat device as claimed in claim 12, wherein, for each of said linkage units, an imaginary line which extends between said first and second pivot portions of said first linking member and an axis along which said protruding portion of said first linking member extends cooperatively define a protruding angle that ranges between 120 degrees and 140 degrees.

14. The capsule seat device as claimed in claim 12, wherein:
said control unit has an end portion formed with a plurality of gear teeth;
for each of said linkage units, said second linking member has a pivot end portion pivotally connected to said second pivot portion of said first linking member, and a gear end portion having a plurality of gear teeth that mesh with said gear teeth of said control unit such that the operation of said control unit drives rotation of said gear end portion of said second linking member, thereby resulting in the pivot movement of said first linking member; and
said capsule seat device further comprises a stopping unit mounted between said side walls of said support wall subunit, and being engaged with said gear teeth of said gear end portion of each of said linkage units when said first linking member of each of said linkage units is at the first position for arresting the rotation of said gear end portion of each of said linkage units, thereby positioning the position of said receiving unit.

15. The capsule seat device as claimed in claim 1, wherein:
said support wall subunit includes two spaced-apart side walls that are respectively connected to opposite ends of said base subunit, each of said side walls being formed with a guiding slot that extends in a direction of the normal axis; and
said receiving unit includes a capsule seat that is adapted for receiving the coffee capsule, and two guiding blocks that protrude from said capsule seat, each of said guiding blocks being engaged with and slidable along said guiding slot of a respective one of said side walls.

16. The capsule seat device as claimed in claim 1, wherein the inclined angle is substantially 30 degrees.
